(19) United States
(12) Patent Application Publication
(10) Pub. No.: US 2010/0095682 A1
(43) Pub. Date: Apr. 22, 2010

(54) Removing Particulate Matter From Air

(76) Inventor: Lincoln Evans-Beauchamp, Palo Alto, CA (US)

Correspondence Address: Carr & Ferrell/Purify, 2200 Geng Road, Palo Alto, CA, 94303-3220, US

(21) Appl. No.: 12/538,761

(22) Filed: Aug. 10, 2009

Related U.S. Application Data
(63) Continuation-in-part of application No. 12/332,312, filed on Dec. 10, 2008.
Application No. 12/332,312 is a continuation-in-part of application No. 12/252,779, filed on Oct. 16, 2008.

(51) Int. Cl. F02C 7/00; F02C 3/04; F02C 7/22

(52) U.S. Cl. 60/783; 60/805; 60/734; 60/39.5

(57) ABSTRACT

An air cleaning system for converting particulates in a gas to a residue may include a compressor and a reverse flow combustion purifier. The compressor may compress the gas and the reverse flow combustion purifier may convert the particulates to the residue. A turbine may use compressed gas from the reverse flow combustion purifier to generate power for driving the compressor. Combustion of the particulates may provide make-up energy for sustaining the air cleaning system. A burner manifold may burn fuel using a portion of the compressed gas. Energy from combustion of the fuel may be used for driving the turbine.

### CROSS-REFERENCE TO RELATED APPLICATIONS

The present application is a continuation in part and claims the priority and benefit of U.S. patent application Ser. No. 12/332,312, filed on Dec. 10, 2008, and entitled “External Compression Two-Stroke Internal Combustion Engine with Burner Manifold,” which is a continuation in part of U.S. patent application Ser. No. 12/252,779, filed on Oct. 16, 2008, and entitled “External Compression Two-Stroke Internal Combustion Engine.” The disclosures of all of the above U.S. patent applications are incorporated by reference herein in their entirety.

### BACKGROUND OF THE INVENTION

1. Field of the Invention

The present disclosure generally relates to an air cleaner for removing particles from air. The present disclosure more specifically relates to using a reverse flow combustion purifier for converting the particles to a residue, which may be used to reduce power consumption by the purifier.

2. Description of Related Art

A gas may include suspended particulate matter, which is sometimes referred to as particulates or particles. The size of particulates may vary across a spectrum. Particulates may be representative of tiny or large solids or liquids suspended in a gas. For example, smaller particulates may be representative of individual molecules. More intermediate sized particulates may be representative of material many microns in diameter and may produce a visible haze. Larger particulates may encompass visible objects such as dust and insects.

Particulates may include organic material such as hydrocarbons. Another type of particulate includes elemental carbon, which is also known as black carbon or soot. Black carbon is composed of pure carbon clusters, skeleton balls, and Bucky balls. Organic matter and elemental carbon together constitute the carbonaceous particulate matter. The gas may include ambient air or gas emitted by an industrial process.

Some particulates are suspended in the atmosphere by natural events such as volcanoes, dust storms, forest and grassland fires, sea spray, living vegetation and animals. Some particulates are contributed by activities such as vehicle traffic, burning fossil fuels, and power plant burn off.

Particulates can be damaging to property and harmful to health. Thus, methods have been developed to remove particulates from air. One method of removing particulates from air is to filter the air. While filtering is generally adequate for small volumes of air, such as inside rooms and buildings, it is inadequate for large volumes of air surrounding buildings, towns, and cities. Filtering also requires substantial amounts of energy for moving the air through a resistance presented by the filter. Further, filters must be cleaned or replaced as they become saturated by particulates.

Another method for removing particulates from air is to convert the particulates to a residue. The residue may be non-harmful or more easily removed. One form of conversion is oxidation of particulates. A temperature of the gas may be raised to a combustion temperature of the particulates and oxygen or other oxidizing agent in the gas may combine with the particulates to produce a particulate residue. For example, various forms of carbon particulates including elemental carbon, carbon monoxide, carbohydrates, organic carbon molecules, hydrocarbons may be oxidized to produce a residue including CO₂ and H₂O. A reduction reaction may also be used to convert particulates to a residue. The temperature of the gas may be raised to a reduction temperature of the particulates and the particulates may be reduced in the presence of a reducing agent or in the absence of an oxidizing agent. For example, oxides of nitrogen (NOx) may be reduced (unburned) in the presence of high energy molecules such as HC and CO. The high energy molecules may receive oxygen from the NOx to produce a residue including N₂.molecules. However, there is no method for oxidizing or reducing particulates in large volumes of air.

### SUMMARY OF THE CLAIMED INVENTION

In an embodiment of the presently claimed invention, a system is provided for converting particles to particle residue. The system includes a compressor configured to compress a gas including the particles. A reverse flow combustion purifier receives the compressed gas and the particles from the compressor and heats the compressed gas and particles to a combustion temperature of the particles. Combustion of the particles converts the heated particles to particle residue. The reverse flow combustion purifier may output the particle residue and heated compressed gas to a turbine. The turbine is configured to receive the heated compressed gas from the reverse flow combustion purifier and use the heated compressed gas for producing power. The turbine is coupled to the compressor and configured to provide the produced power to the compressor for driving the compressor.

In an embodiment of the presently claimed invention, a method is provided for converting particles in a gas to a residue. The method includes compressing the gas in a compressor and heating the particles in the compressed gas to a first temperature. The particles are heated in a reverse flow combustion purifier. The method further includes combusting the heated particles in the reverse flow combustion purifier to convert the heated particles to a particle residue. The heated compressed gas is provided from the reverse flow combustion purifier to a turbine. The heated compressed gas is used for driving the turbine to generate power. The power generated in the turbine is provided to the compressor to use for compressing the gas.

In an embodiment of the presently claimed invention, a system is provided for converting particles to particle residue. The system includes a compressor and a reverse flow combustion purifier. The compressor is configured to compress a gas to a first pressure, the gas including particles. The reverse flow combustion purifier includes an intake chamber, a combustion chamber, and an exit chamber. The intake chamber is configured to receive the compressed gas from the compressor at the first pressure. The combustion chamber is configured to receive the compressed gas from the intake chamber and heat the compressed gas and included particles to a combustion temperature of the particles to generate a particle residue from combustion of the particles. The exit chamber is configured to receive the particle residue and the heated compressed gas from the burner chamber and to expel the particle residue and the heated compressed gas from the combustion purifier. The reverse flow combustion purifier further includes a thermal conductor disposed between the intake chamber and the exit chamber. The thermal conductor is configured to transfer heat from the heated compressed gas and particle residue in the exit chamber to the compressed gas in the intake chamber. The system may further include a turbine coupled to the reverse flow combustion purifier. The turbine may be configured to receive the heated compressed gas from the reverse flow combustion purifier. The heated compressed gas may be used for driving the turbine to generate power. The turbine may be further coupled to the compressor and configured to provide the generated power to the compressor.

### BRIEF DESCRIPTION OF THE DRAWINGS

FIG. 1 illustrates an air cleaning system.

FIG. 2 is a block diagram illustrating details of the air purifier system of FIG. 1.

FIG. 3 is a block diagram illustrating details of a combustion purifier.

FIG. 4 is a block diagram illustrating a further embodiment of the air purifier system of FIG. 2.

FIG. 5 is a block diagram illustrating a further embodiment of the air purifier system of FIG. 2.

FIG. 6 is a block diagram illustrating a further embodiment of the air purifier system of FIG. 5.

FIG. 7 is a block diagram illustrating a further embodiment of the air purifier system of FIG. 4.

FIG. 8 is a block diagram illustrating a further embodiment of the air purifier system of FIG. 2.

FIG. 9 is a block diagram illustrating an alternative embodiment of the air purifier system of FIG. 2.

FIG. 10 is a flow diagram of an exemplary process for purifying air.

### DETAILED DESCRIPTION

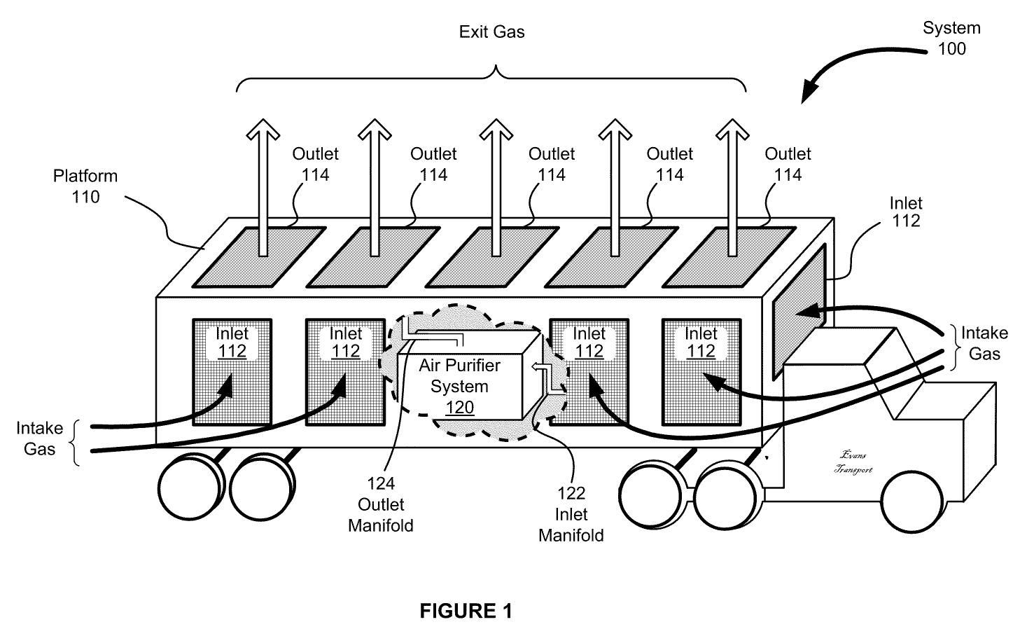

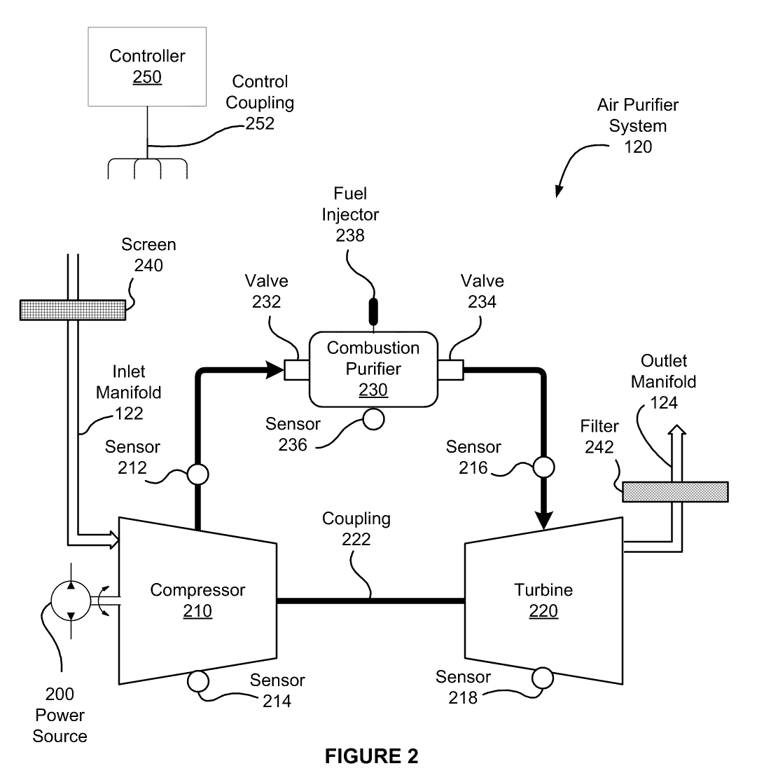

FIG. 1 illustrates an air cleaning system 100. The air cleaning system 100 includes a platform 110 and an air purifier system 120 as described in greater detail in the context of FIG. 2. The platform 110 of FIG. 1 includes inlets 112 for receiving an intake gas, which may include particulates. The inlets 112 may be coupled to the air purifier system 120 via an inlet manifold 122. The air purifier system 120 may remove the particulates from the intake air and output an exit gas. Alternatively, the air purifier system 120 converts the particulates to a residue via an oxidation or a reduction reaction. The exit gas may include the particulate residue. The platform 110 of FIG. 1 further includes outlets 114 for outputting the exit gas. The air purifier system 120 may be coupled to the outlets 114 via an outlet manifold 124.

The platform 110 of FIG. 1 is configured to allow for transporting the air cleaning system 100. For example, the platform 110 may be integrated with a tractor-trailer thereby allowing the platform 110 to be driven on a road. The air cleaning system 100 may be driven on the road to continuously provide fresh ambient air for the intake gas. Thus, large volumes of air may be processed along the road to remove air pollution generated by traffic. The air cleaning system 100 may also be stationary or permanently positioned at a site for processing gas emissions such as those from a machine, an engine, or an industrial process.

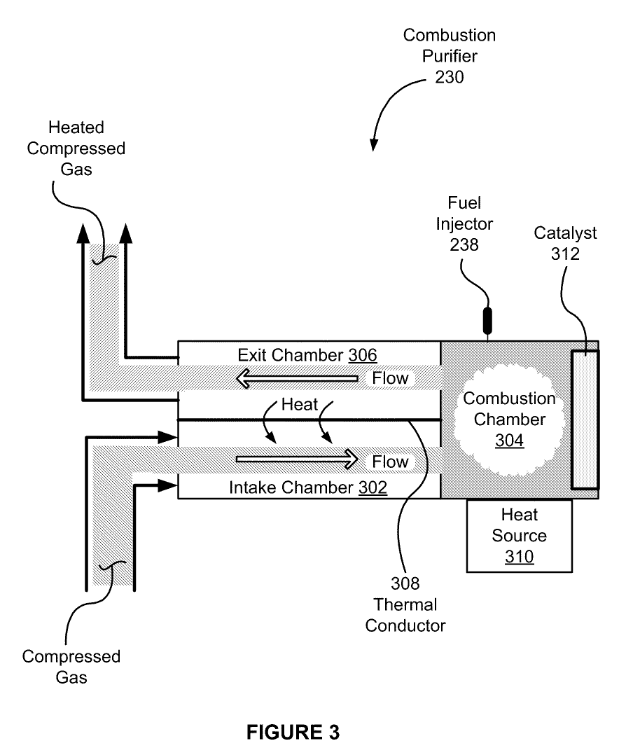

FIG. 2 is a block diagram illustrating details of the air purifier system 120 of FIG. 1. The air purifier system 120 of FIG. 2 includes a compressor 210, turbine 220, and combustion purifier 230 as described in greater detail in the context of FIG. 3. The compressor 210 may be driven using a power source 200. The power source 200 may be a torque source. Various examples of the power source 200 include an electric motor, a pneumatic motor, a gasoline engine, a diesel engine, a gas turbine, and an alternative fuel engine. The compressor 210 receives intake gas from the inlet manifold 122. The compressor 210 compresses the intake gas and outputs a compressed gas. The compression of the intake gas may be performed adiabatically and the temperature of the compressed gas may, further, be increased by the compression to about a combustion temperature and pressure of particulates in the intake gas.

The combustion purifier 230 of FIG. 2 is configured to convert the particulates in the compressed gas to a particulate residue. The combustion purifier 230 receives the compressed gas including particulates from the compressor 210. The conversion of the particulates to a residue in the combustion purifier 230 may include an exothermic reaction that can provide heat for heating the compressed gas. In some environments, the energy content of the particulates in the air contributes enough heat to sustain the temperature within the combustion purifier 230 at an auto ignition temperature of the particulates. The combustion purifier 230 may use fuel to further heat the compressed gas. A fuel injector 238 may receive fuel from a fuel source (not illustrated) and subsequently inject that fuel into the combustion purifier 230. Combustion of the fuel in the combustion purifier 230 provides additional heat for heating the compressed gas. The injected fuel may be any combination of solid, liquid, vapor, and gas. The combustion purifier 230 outputs heated compressed gas and particulate residue to the turbine 220.

The turbine 220 receives the heated compressed gas from the combustion purifier 230. The heated compressed gas is used for driving the turbine 220. Exit gas may be output from the turbine 220 via the outlet manifold 124. The outlet manifold 124 is configures to release the exit gas to ambient air via the outlet 114.

The turbine 220 is coupled to the compressor 210 via a coupling 222. Power and/or torque from the turbine 220 may be used for driving the compressor 210. Examples of the coupling 222 include a drive shaft, transmission, pneumatics, electrical motors, and electrical conductors.

One or more valves may be used for controlling volume and flow of gas in the air purifier system 120. Examples include valves 232 and 234. The valve 232 may be implemented to control a volume and/or rate of compressed gas received by the combustion purifier 230 from the compressor 210. The valve 234 may be implemented to control a volume and/or rate of the heated compressed gas received by the turbine 220 from the combustion purifier 230.

The air purifier system 120 may operate in a closed loop mode. An example of a closed loop includes the compressor 210, the turbine 220 and the combustion purifier 230. Energy losses due to inefficiencies such as friction, entropy, turbulence, drag in the turbine, drag in the compressor are inherent in such a closed loop system. Closed loop operation of the air purifier system 120 generally is not self-sustaining without a source of additional energy or ‘make-up’ energy to compensate for such losses. Make-up energy may be added to sustain operation of the air purifier system 120 in a closed loop mode.

Make-up energy may be provided from a number of sources. The energy produced by an exothermic reaction between the particulates and the compressed gas can be a source of make-up energy for the air purifier system 120. For example, oxidation of particulates may provide sufficient heat energy to sustain operation of the air purifier system 120 in the closed loop mode. This may occur when the particulates are highly concentrated in the compressed gas and/or have a high energy content. Examples include heavily polluted air or a swarm of insects.

Typically, the energy content of the particulates is not sufficient to sustain the air purifier system 120 in the closed loop mode. An endothermic reaction in the combustion purifier 230 would also not provide any make-up energy to the system. All or some of the supplemental make-up energy may be supplied by fuel that is injected into the combustion purifier 230 using the fuel injector 238.

The air purifier system 120 may also be operated in an open loop mode. Energy for driving the air purifier system 120 in open loop mode may be provided from an external source. For example, the power source 200 may be an electric motor that receives electrical energy from an external source. In another example, a diesel engine may be coupled to the compressor 210 or the turbine 220. A combination of energy produced by an exothermic reaction of particulates, fuel injected into the combustion purifier 230, and/or an external energy source may be used for operation of the air purifier system 120.

An optional screen 240 is disposed in series with the inlet manifold 122. The screen 240 may be disposed before or after one or more of the inlets 112. The screen 240 is configured to pass the particulates while removing larger objects such as debris, pebbles, rocks, insects, small animals, and birds. An optional filter 242 may be disposed in series with the exit manifold 124. When disposed in series with the manifold 124, the filter 242 is configured to remove the particulate residue. The filter 242 may be disposed before or after one or more of the outlets 114. As illustrated in FIG. 2, the filter 242 is disposed after the turbine 220. The filter 242 may, however, be disposed between the combustion purifier 230 and the turbine 220.

Referring to FIG. 2, a controller 250 is coupled to the air purifier system 120 via a control coupling 252. The controller 250 may include one or more computer systems, computer interfaces, memory, or a combination thereof. The control coupling 252 is configured to communicate data from sensors to the controller 250. The control coupling 252 may further communicate control commands from the controller 250 to components of the air purifier system 120, including the valves, the compressor 210, the fuel injector 238, the turbine 220 and/or the combustion purifier 230. The control coupling 252 may include various combinations of wiring harnesses, relays, circuit boards, processors, optical transmitters, optical cable, optical receivers, wireless transmitters, wireless receivers, electrical actuators, a hydraulic lines, hydraulic actuators, pneumatic lines, and pneumatic actuators.

The controller 250 of FIG. 2 is coupled to sensors 212, 214, 216, 218, and 236. The sensor 212 includes one or more components configured to sense various parameters of the compressed gas from the compressor 210. The sensor 236 includes one or more components configured to sense various parameters of the combustion purifier 230. The sensor 216 includes one or more components configured to sense various parameters of the heated compressed gas emitted from the combustion purifier 230. The sensor 214 includes one or more components configured to sense various parameters of the compressor 210. The sensor 218 includes one or more components configured to sense various parameters of the turbine 220. While five sensors, namely sensor 212, 214, 216, 218, and 236 are illustrated in FIG. 2, more or fewer sensors may be used. For example, sensors may be disposed on one or more of the valves (not illustrated) and configured to sense a state of the valves. Each of the sensors can be used to measure one or more parameters such as including pressure, temperature, volume, flow, velocity, RPM and torque.

The controller 250 may be configured to control a timing of the valve 232, the fuel injector 238, the valve 234, or a combination thereof based data received from the sensors 212, 214, 216, 218, and/or 236. For example, the controller 250 may be coupled to the valve 232 and/or the valve 234 and configured to control opening and closing of these valves. The controller 250 may be coupled to the fuel injector 238 and configured to control timing of the fuel injector 238.

The controller 250 may be coupled to the compressor 210, the power source 200, the turbine 220, or the combustion purifier 230, or any combination of the forgoing. The controller 250 may control output pressure and RPM of the compressor 210. The controller 250 may control RPM of the power source 200 and/or the turbine 220. The controller 250 may control temperature in the combustion purifier 230. For example, the controller 250 may regulate an amount of fuel introduced into the combustion purifier 230 using the fuel injector 238 to control the temperature in the combustion purifier 230.

The controller 250 may include one or more processors. For example, a first processor in the controller 250 may be configured to control valves and injectors such as one or more of valve 232, valve 234, and fuel injector 238, while a second processor in the controller 250 is configured to control the compressor 210. A third processor may be configured to receive data from sensors such as sensors 212, 214, 216, 218, and 236 and communicate the data to the first and/or second processor. Controller 250 can include a processor used to control or receive data in place of two or more of the above described processors.

FIG. 3 is a block diagram illustrating details of the combustion purifier 230 of FIG. 2. The combustion purifier 230 of FIG. 3 includes an intake chamber 302, a combustion chamber 304 and an exit chamber 306. The intake chamber 302 is coupled to the combustion chamber 304 and to the compressor 210 via the valve 232. The intake chamber 302 receives compressed gas from the compressor 210 and couples the compressed gas to the combustion chamber 304.

The combustion chamber 304 of FIG. 3 may heat the compressed gas to a combustion temperature of the particulates and convert the particulates to a residue. The conversion of the particulates to a residue may be accomplished by an oxidation reaction between the particulates and oxygen and/or or other oxidizing agent in the compressed gas. For example, carbon particulates such as organic molecules, hydrocarbons, soot, and insects may be burned to produce a residue of CO₂ and water. Oxidation reactions may occur at a combustion temperature and pressure for the particulates. Typical combustion temperatures include a range of 300-1200° F. The auto ignition temperature of various substances can vary due to factors such as partial pressure of oxygen, altitude, humidity, and amount of time for ignition. Examples of typical auto ignition temperatures for various molecules and substances include:
Triethylborane: −20° C. (−4° F.)
Silane: <21° C. (70° F.)
White phosphorus: 34° C. (93° F.)
Carbon disulfide: 90° C. (194° F.)
Diethyl ether: 160° C. (320° F.)
Diesel or Jet A-1: 210° C. (410° F.)
Paper: 218°-246° C. (424-474° F.)
Gasoline (Petrol): 246-280° C. (475-536° F.)
Magnesium: 473° C. (883° F.)
Butane: 405° C. (761° F.)
Hydrogen: 536° C. (997° F.)
   Typical pressures for combustion include a range of 3-4 times ambient pressure. The oxidation of the particulates may be exothermic or endothermic.

The conversion of the particulates to a residue may be accomplished by a reduction reaction. Reduction is a process that is used to “unburn” NOx, by burning NOx with other high energy molecules such as HC and CO. The high energy molecules may receive Oxygen from the NOx. In other words, the NOx may burn the HC/CO/PM leaving a residue including N2. The reduction of particulates may be exothermic or endothermic.

The exit chamber 306 of FIG. 3 is coupled to the combustion chamber 304. The exit chamber 306 is further coupled to the turbine 220 via the valve 234. The exit chamber may receive heated compressed gas from the combustion chamber 304 and provide the heated compressed gas to the turbine 220. FIG. 3 illustrates the direction of flow of the heated compressed gas in the exit chamber 306 as being about opposite to the direction of flow of the compressed gas in the intake chamber 302.

A thermal conductor 308 may be disposed between the intake chamber 302 and the exit chamber 306. The thermal conductor 308 may be thermally coupled to the exit chamber 306 and the intake chamber 302. The thermal conductor 308 may function as a reverse flow heat exchanger. As the gas flows in opposite directions in contact with the thermal conductor 308, heat from the heated compressed gas in the exit chamber 306 may be transferred to the compressed gas in the intake chamber 302. Thus, heat energy in the heated compressed gas in the exit chamber 306 may be recovered and used to preheat the compressed gas in the intake chamber 302.

A heat source 310 may be used to heat the compressed gas in the combustion chamber 304. The heat source 310 may be an internal heat source or an external heat source. For example, a radiant heat source may be disposed inside or around the outside of the combustion chamber 304. The heat source 310 may include fuel that is injected into the combustion purifier via the fuel injector 238. The fuel may be burned to provide heat using oxygen in the compressed gas. Heat from the heat source 310 may initiate a reaction between the compressed gas and the particulates to convert the particulates to a residue.

A catalyst 312 may be disposed inside the combustion chamber 304 to reduce the combustion temperature or the particulates. The catalyst 312 may catalyze a reaction between the particulates and the gas to enable the reaction to occur at lower temperatures. Other aspects and examples of a combustion purifier are set forth in further detail in U.S. patent application Ser. Nos. 12/271,777; 12/202,186; 11/787,851; 11/800,110; 11/412,289; and 11/404,424, as well as U.S. Pat. No. 7,500,359. The disclosure of each of the aforementioned applications and patent is incorporated herein by reference in its entirety.

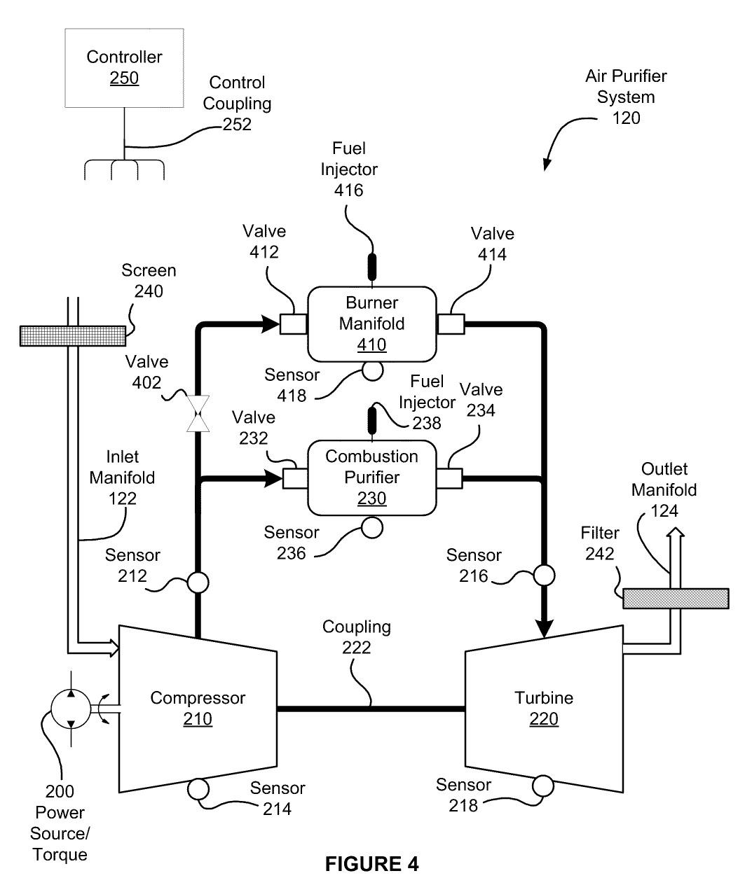

FIG. 4 is a block diagram illustrating a further embodiment of the air purifier system 120 of FIG. 2. FIG. 4 differs from FIG. 2 in that air purifier system 120 of FIG. 4 includes a burner manifold 410 in parallel with the combustion purifier 230. In FIG. 4, a valve 412 is disposed between the burner manifold 410 and the compressor 210. A valve 414, in turn, is disposed between the burner manifold 410 and the turbine 220 as illustrated in FIG. 4. An example of a temperature and pressure of the compressed gas received from the compressor 210 may be in the range of 200-400° F. and 1.5-4 times ambient pressure. An example of a temperature and pressure of the heated compressed gas emitted from the combustion purifier 230 may be in the range of 300-1200° F. and 1.5-4 times ambient pressure. An example of a temperature of the exhaust gas emitted from the turbine 220 may be in the range of 150-800° F.

The burner manifold 410 may provide a source of make-up energy for sustaining the air purifier system 120 in a closed loop mode, where the closed loop mode involves the compressor 210, the turbine 220, the combustion purifier 230, and the burner manifold 410. The additional or make-up energy provided by the burner manifold 410 may compensate for losses due to inefficiencies in the air purifier system 120.

The burner manifold 410 may receive a portion of the compressed gas via the valve 412 from the compressor 210. An optional one-way valve 402 may be used for maintaining pressure in the burner manifold 410. A fuel injector 416 may receive fuel from a fuel source (not illustrated) and subsequently inject that fuel into the burner manifold 410 for combustion with the compressed gas in the burner manifold 410. The injected fuel may be in the form of solid, liquid, vapor, and/or gas. The fuel and compressed gas may combine in the burner manifold 410 to form a fuel/gas mixture. When the temperature of the compressed gas is at or above the auto ignition temperature of the fuel, the fuel/gas mixture spontaneously combusts to form the combustion gas. The fuel/gas mixture rapidly forms a combustion gas within the burner manifold 410 in the combustion purifier 230. A typical auto ignition temperature for fuels such as diesel is about 800-1700° F. at about 8-16 times ambient pressure.

Alternatively, the compressor 210 may heat the gas to a temperature below the auto ignition temperature for the fuel. Ignition of the fuel/gas mixture can be initiated using a heat source such as a spark or a glow plug. Internal surface features such as baffling, corners, joints, etc., within burner manifold 410 might create local hot spots as a result of uneven flow or turbulence of the fuel/gas mixture. The local hot spots can exceed the auto ignition temperature of the fuel, and initiate ignition of the fuel/gas mixture.

While FIG. 4 illustrates a fuel injector 416, fuel may be introduced into the burner manifold 410 using other devices. For example, a carburetor (not illustrated) may be used to mix atomized fuel with the compressed gas before introduction into the burner manifold 410. In such case, the temperature of the compressed gas is maintained below the auto ignition temperature for the fuel. Ignition of the fuel/gas mixture may be initiated using a spark plug or a glow plug. The burner manifold 410 may include a catalyst configured to promote combustion of the fuel at a lower temperature. Examples of catalysts include Platinum, Palladium, and Rhodium. A spark plug or a glow plug may be used to initiate combustion at lower temperatures of the fuel gas mixture in the presence of the catalyst.

Generally, the combustion purifier 230 receives a larger portion of the compressed gas than the burner manifold 410. For example, the burner manifold 410 may be configured to provide sufficient energy to drive the turbine 220 and the compressor 210 using a negligible portion of the compressed air. The combustion purifier 230 may convert particulates in the rest of the compressed air to residue and provide a negligible portion of the energy. The combustion purifier 230 may also receive fuel via the fuel injector 238 for promoting and/or sustaining combustion of the particulates within the combustion purifier 230.

The sensor 418 may be coupled to the controller 250 via the control coupling 252. The sensor 418 includes one or more components configured to sense parameters relating to the burner manifold 410 such as pressure, temperature, volume, flow, and velocity. The controller 250 may be coupled to the fuel injector 416, the valve 412, and/or the valve 414 via the control coupling 252. The controller 250 may adjust a flow and/or pressure of compressed gas entering the burner manifold 410 using the valve 412. The controller may adjust a flow and/or amount of combustion gas exiting the burner manifold 410 using the valve 414. The controller 250 may adjust a ratio of compressed gas entering the burner manifold 410 to the compressed gas entering the combustion purifier 230. The controller 250 may adjust an amount of fuel entering the burner manifold 410 using the fuel injector 416. The controller 250 may control a temperature in the burner manifold 410. For example, the controller 250 may regulate the amount of fuel introduced into the burner manifold 410 using the fuel injector 416.

The combustion gas formed in the burner manifold 410 is provided to the turbine 220 and used to drive the turbine 220. The turbine 220 in turn is used to drive the compressor 210. Energy stored in the fuel is released by combustion of the fuel in the burner manifold 410. The released energy is used to compensate for energy lost in system components such as the compressor 210, the combustion purifier 230, and the turbine 220. Combustion gas from both the combustion purifier 230 and the burner manifold 410 may be used to drive the turbine 220.

The energy from the fuel may increase the temperature and/or velocity of molecules of the combustion gas. While the pressure of the combustion gas exiting the burner manifold 410 may be lower than the pressure of the compressed gas entering the burner manifold 410, the energy content of the combustion gas, represented by temperature and/or velocity of the combustion gas, is higher than the compressed gas. The increased temperature and/or velocity of the molecules in the combustion gas may be used to drive the turbine 220.

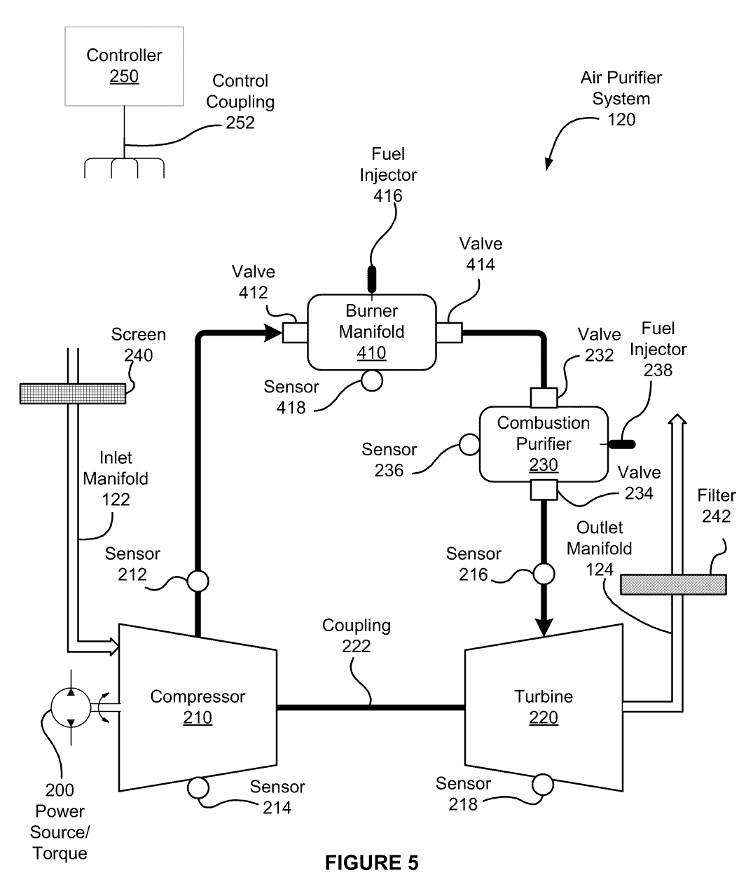

FIG. 5 is a block diagram illustrating a further embodiment of the air purifier system 120 of FIG. 2. FIG. 5 is also an alternative embodiment of FIG. 4 and differs from FIG. 4 in the arrangement of the components. The burner manifold 410 in FIG. 5 is in series with the combustion purifier 230 instead of in parallel as in FIG. 4. The burner manifold 410 of FIG. 5 receives the compressed gas from the compressor 210 and provides heated compressed gas to the combustion purifier 230.

The controller 250 may adjust the fuel injector 416 to meter the fuel injected into the burner manifold 410 for a relatively lean or a relatively rich fuel/gas mixture. A lean mixture generally results in complete combustion of the fuel in the presence of excess oxygen. Combustion of the fuel in the burner manifold 410 may be used to raise the temperature of the combustion gas to the combustion temperature of the particulates while leaving residual oxygen in the combustion gas. The combustion gas, including the residual oxygen, from the burner manifold 410 is then provided to the combustion purifier 230. The residual oxygen is used in the combustion purifier 230 for oxidation of the particulates to a residue.

A rich mixture generally results in complete depletion of the oxygen in the compressed gas upon combustion of the fuel with the gas. The oxygen depleted gas may be provided to the combustion purifier 230 and used for reducing the particulates. A fuel having a combustion temperature that is less than the combustion temperature of the particulates in the gas can be used. The particulates can then be reduced in the combustion purifier 230 at a temperature below the combustion temperature of the particulates.

The heated combustion gas formed in the burner manifold 410 is provided to the combustion purifier 230 for conversion of the particulates to a residue. The combustion purifier 230 may receive fuel via the fuel injector 238 for promoting and/or sustaining combustion of the particulates. Heated combustion gas from the combustion purifier 230 is used for driving the turbine 220 which in turn is coupled to the compressor 210 and used for driving the compressor 210 as discussed elsewhere herein.

The controller 250 may control temperatures in the burner manifold 410. For example, the controller 250 may adjust the fuel injector 416 regulate an amount of fuel and the valve 412 to regulate an compressed air introduced into the burner manifold 410. The regulation of the fuel injector 416 and the valve 412 may be based on the temperature in the combustion purifier 230 sensed using the sensor 236. Similarly, the controller 250 may regulate a temperature in the combustion purifier 230 using the fuel injector 238 and the valve 232 based on a temperature sensed in the burner manifold 410 using the sensor 418.

The controller 250 may adjust the fuel/gas mixture for a rich or lean mixture to control the temperature of the combustion gas. For example, the temperature of the combustion gas generally increases as a rich fuel/gas mixture is leaned, either by adding more gas or less fuel. The temperature of the combustion gas reaches a maximum and then decreases as the mixture is leaned further.

The burner manifold 410 of FIG. 5 is disposed between the compressor 210 and the combustion purifier 230. Thus, the intake chamber 302 of the combustion purifier 230 is configured to receive compressed gas from the burner manifold 410, and the exit chamber 306 of the combustion purifier 230 is configured to provide the compressed gas to the turbine 220. In such a configuration, the compressed gas is provided to the burner manifold 410 for heating. The heated compressed gas is then provided to combustion purifier 230 where the heated particulates are converted to residue.

The combustion purifier 230 may be disposed, however, between the compressor 210 and the burner manifold 410. The intake chamber 302 of the combustion purifier 230 may be configured to receive compressed gas from the compressor 210, and the exit chamber 306 of the combustion purifier 230 may be configured to provide the compressed gas to the burner manifold 410. In such a configuration, the particulates are converted to residue in the combustion purifier 230 before the compressed gas is provided to the burner manifold 410 for heating. The burner manifold 410 can then further heat the compressed air and residue to a temperature well above an operating temperature range of the catalyst 312 in the combustion purifier 230 without damaging the catalyst 312. The burner manifold 410 in turn provides the heated compressed gas to the turbine 220 for driving the compressor 210 as discussed elsewhere herein.

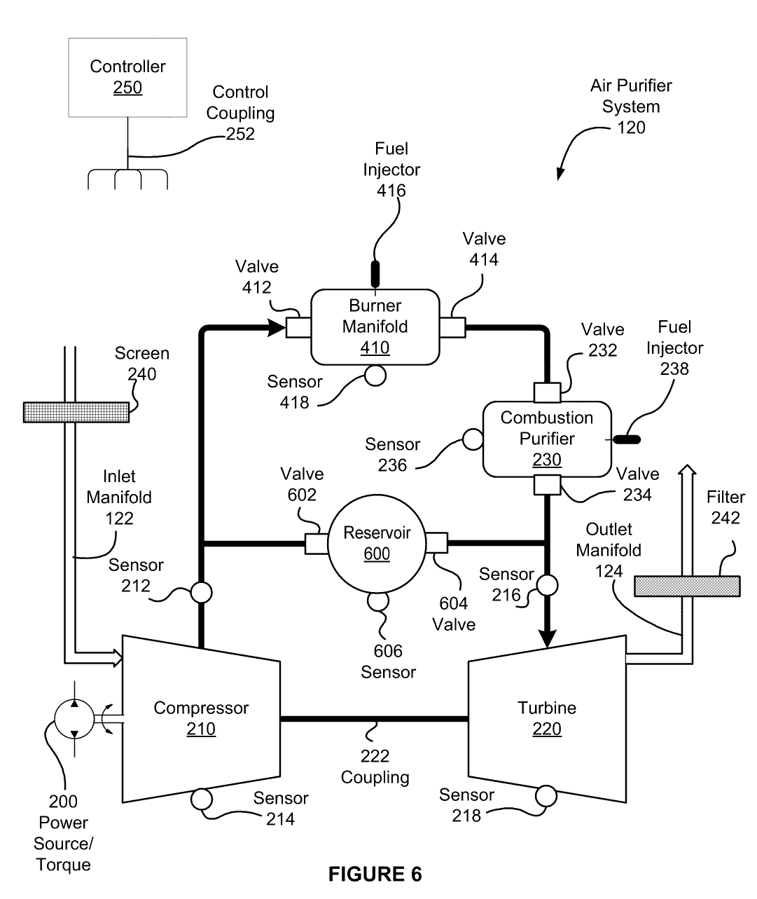

FIG. 6 is a block diagram illustrating a further embodiment of the air purifier system 120 of FIG. 5. FIG. 6 differs from FIG. 5 in that a reservoir 600 is disposed in parallel with the series burner manifold 410 and combustion purifier 230, the burner manifold 410 being in series with the combustion purifier 230. The reservoir 600 of FIG. 6 is configured to receive a portion of the compressed gas via a valve 602 from the external compressor 210 and store the compressed gas. The reservoir 600 may provide compressed gas to the turbine 220 for driving the turbine 220. A sensor 606 may be coupled to the reservoir 600 and configured to provide data to the controller 250 via the control coupling 252. The sensor 606 includes one or more components configured to sense various parameters of the reservoir 600 including a pressure, temperature, volume, and flow.

The reservoir 600 may be insulated to maintain the temperature of the compressed gas in the reservoir 600. A heater (not shown) may be disposed in or around the reservoir to heat the compressed gas to make up for heat lost during storage. The compressed gas in the reservoir 600 may be used for starting the turbine 220 or keeping it running when heated compressed gas is not available from the combustion purifier 230. The compressed gas may be provided from the reservoir 600 to the burner manifold 410 via valves 602 and 412, for example, when the compressor 210 is not running. The valves 602 and/or 604 may be used as one-way valves for maintaining storage of the compressed gas in the reservoir 600.

The reservoir 600 is illustrated in FIG. 6 as being in parallel with a series configuration of the burner manifold 410 and the combustion purifier 230. The reservoir 600 may be disposed, however, in series (not illustrated) with the burner manifold 410 and the combustion purifier 230. Alternatively, the reservoir 600 may be disposed in parallel or series (not illustrated) with the parallel configuration of the burner manifold 410 and the combustion purifier 230 of FIG. 4. The burner manifold is illustrated in FIG. 6 as being disposed between the compressor 210 and the combustion purifier 230. The combustion purifier 230 may be disposed, however, between the compressor 210 and the burner manifold 410.

The controller 250 may adjust the valves 602 and 604 to regulate an amount and/or pressure of compressed gas in the reservoir 600 based on pressure and/or temperature in the reservoir 600 sensed using the sensor 606. The controller 250 may adjust the amount and/or pressure of the compressed gas in the reservoir 600 based on pressure and/or temperature in the burner manifold 410 sensed using the sensor 418. Similarly, the controller 250 may adjust the amount and/or pressure of the compressed gas in the reservoir 600 based on pressure and/or temperature in the combustion purifier 230 sensed using the sensor 236.

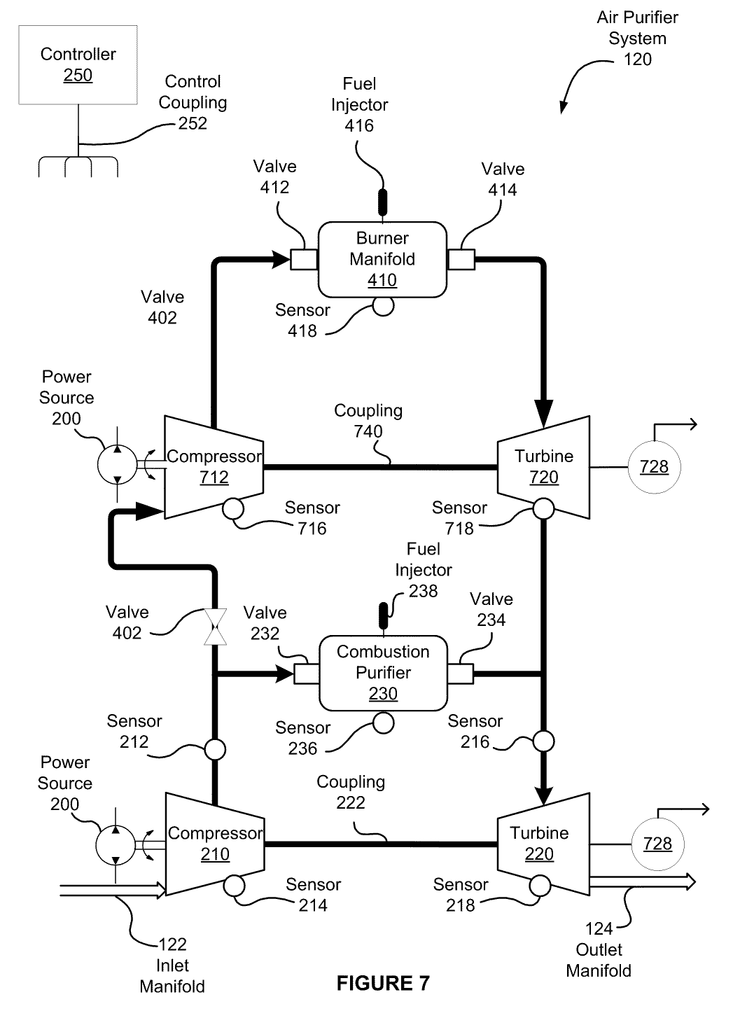

FIG. 7 is a block diagram illustrating a further embodiment of the air purifier system 120 of FIG. 4. FIG. 7 differs from FIG. 4 in that FIG. 7 illustrates multiple stage compressors and multiple stage turbines instead of a single stage compressor and turbine. In FIG. 7, a compressor 712 is arranged as a second stage of a two stage configuration including the compressor 210. The compressor 210 is configured to compress a gas and provide compressed gas to the combustion purifier 230 and the compressor 712 at a first pressure. The first pressure may be 3-4 times ambient at the inlet manifold 122.

The compressor 712 may receive compressed gas at the first pressure from the compressor 210 and further compress the gas to a second pressure. If the second pressure is about 4-5 times the first pressure then the second pressure may be about 12-20 times the ambient pressure of gas at the inlet manifold 122. The valve 402 may control a volume and flow of gas to the compressor 712. The valve 402 may be a one way valve. An optional intercooler (not illustrated) may be disposed between the compressor 210 and the compressor 712 to cool the compressed gas received by the compressor 712. Similar to compressor 210, the compressor 712 may be driven using a power source 200. The screen 240 and the filter 242 have been omitted for clarity.

Alternatively, the compressor 712 may also receive gas at ambient pressure from the inlet manifold 122 (not illustrated) instead of from the compressor 210. The compressor 210 may compress the gas to a first pressure for the combustion purifier 230. The compressor 712 may compress the gas to a second pressure for the burner manifold 410. The first pressure may be independent of the second pressure. Thus, the combustion purifier 230 may receive compressed gas at a first pressure and temperature that is optimized for converting particulates to residue. The burner manifold 410 may receive compressed gas at a second pressure and temperature that is optimized for combustion of fuel to efficiently drive a turbine.

FIG. 7 further differs from FIG. 4 in that FIG. 7 includes a second turbine stage 720. The turbines 220 and 720 of FIG. 7 are arranged in a two stage configuration. The turbine 720 is used to extract energy from compressed heated gas received from the burner manifold 410. The turbine 220 may, in turn, receive the heated compressed gas at a reduced pressure from turbine 720 and extract additional energy from the heated compressed gas. Turbine 220 may be configured to drive compressor 210 using coupling 222 and turbine 720 may be configured to drive compressor 712 using a coupling 740.

FIG. 7 further illustrates energy storage 728 coupled to the turbines 220 and 720. Examples of components for energy storage 728 include generators, batteries, flywheels, and reservoirs. Energy stored in the energy storage 728 may be provided to the power source 200, for example, for starting the compressor 210.

The controller 250 of FIG. 7 is coupled to the compressor 712 and the turbine 720 via the control coupling 252 and configured to control the compressor 712 and the turbine 720 as described elsewhere herein. The controller 250 of FIG. 7 is also coupled to sensors 716 and 718 via the control coupling 252. The sensor 716 may include one or more components configured to sense various parameters of the compressor 712 including an RPM temperature, pressure, volume, flow. The sensor 718 may include one or more components configured to sense various parameters of the turbine 720 including a pressure, temperature, volume, flow, RPM, torque.

The controller 250 may control the first pressure and temperature of the compressed gas independently of the second pressure and temperature of the compressed gas. For example, the controller 250 may control the compressor 210 and the valve 232 to adjust the first pressure and temperature of the compressed gas received by the combustion purifier 230. The controller 250 may independently control the compressor 712, the valve 402, and the valve 412 to adjust the second pressure and temperature of the compressed gas received by the burner manifold 410.

While a two stage compressor system is illustrated in FIG. 7, more than two stages of compressor may be used to provide compressed gas to the combustion purifier and the burner manifold 410. Further, more than two stages of turbines may be used to extract energy from heated compressed gas. Alternatively, the turbine 720 may be combined with the turbine 220 as a single turbine coupled to the compressor 210 and/or the compressor 712.

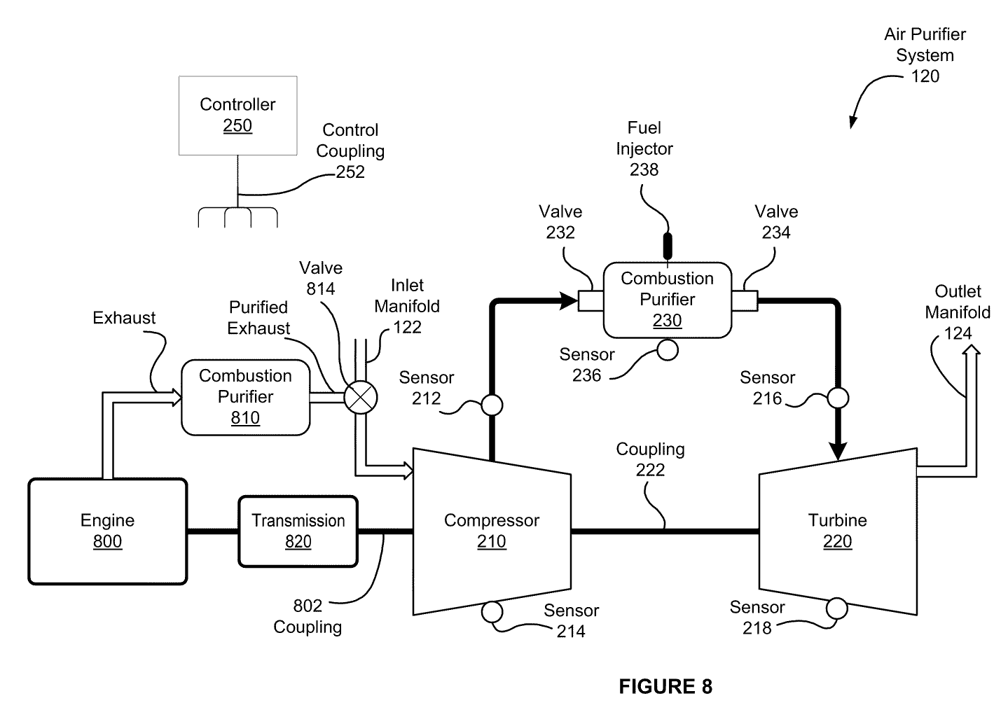

FIG. 8 is a block diagram illustrating an alternative embodiment of the air purifier system 120 of FIG. 2. FIG. 8 differs from FIG. 2 in that FIG. 8 further includes an engine 800 coupled to the compressor 210 via a transmission 820. FIG. 8 also includes a combustion purifier 810 disposed between the engine 800 and the compressor 210. The combustion purifier 810 is configured to receive exhaust gas from the engine 800 and convert particulates in the exhaust gas to a residue. The controller 250 may use a valve 814 to select gas for input to the compressor 210 from the combustion purifier 810 and/or the inlet manifold 122. The controller 250 may use the transmission 820 for adjusting torque applied to the compressor 210 by the engine 800. The screen 240 and the filter 242 have been omitted for clarity. Examples of the engine 800 include a diesel engine, a gasoline engine, a fossil fuel/electric hybrid engine, a natural gas engine.

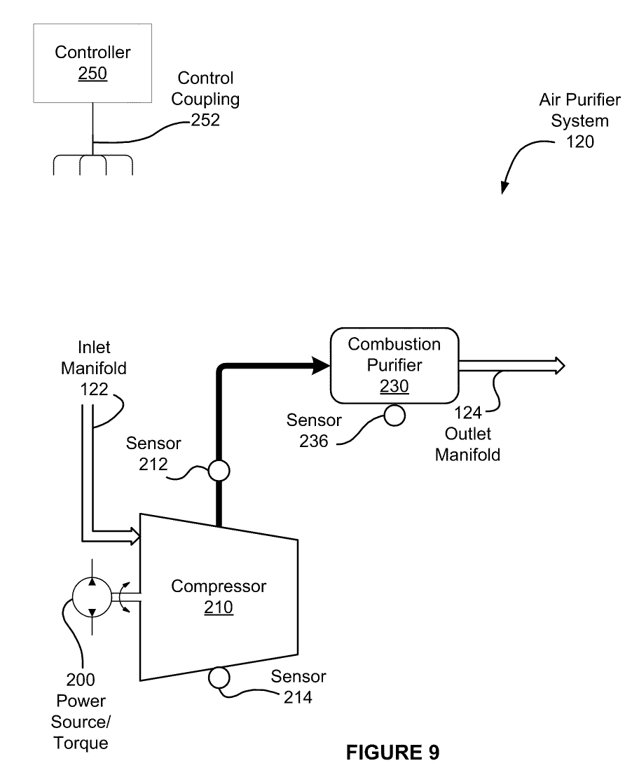

FIG. 9 is a block diagram illustrating an alternative embodiment of the air purifier system 120 of FIG. 2. FIG. 9 differs from FIG. 2 in that the turbine 220 and coupling 222 have been omitted. Energy for driving the compressor 210 may be provided by the power source 200.

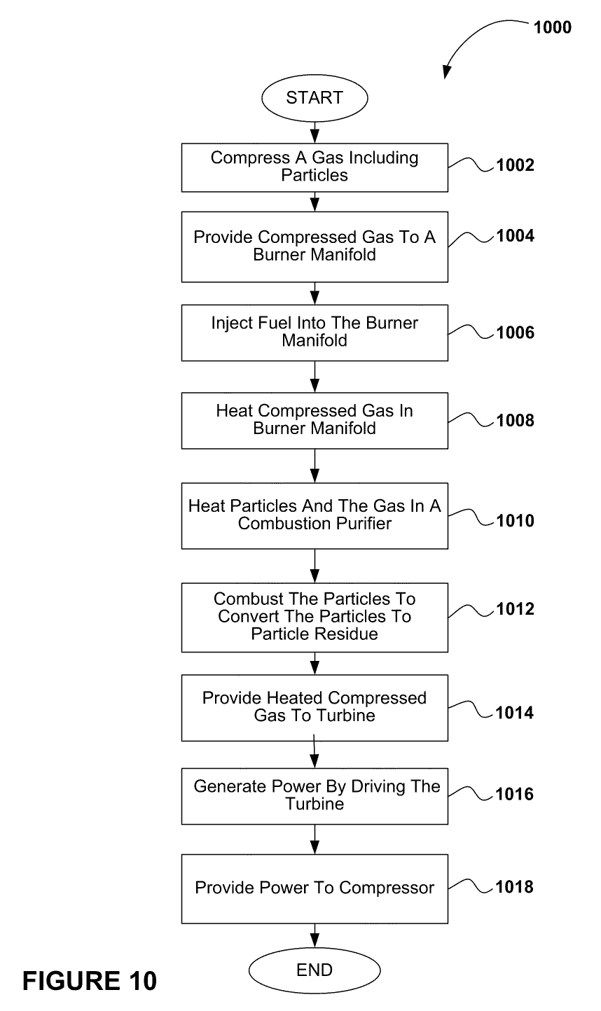

FIG. 10 is a flow diagram of an exemplary process 1000 for converting particles in a gas to a residue, according to various embodiments of the technology. In step 1002, a gas including particles is compressed in a compressor. In step 1004, the compressed gas and the particles are provided to a burner manifold. In step 1006, a fuel is injected into the burner manifold. In step 1008, a mixture of the compressed gas and the fuel combust in the burner manifold and heat the compressed gas to a first temperature. The first temperature may be a combustion temperature of the particles and/or the fuel. The heated compressed gas may be provided to a turbine. Alternatively, the heated compressed gas may be provided to a reverse flow combustion purifier.

In step 1010, particles in the compressed gas may be heated to a second temperature in the reverse flow combustion purifier. The compressed gas and particles may be received from the compressor. Alternatively, the compressed gas and particles are received from the burner manifold. The compressed gas and particles may be received from the burner manifold and the compressor. The second temperature may be a combustion temperature of the particles. In step 1012, a particle residue is produced from combustion of the heated particles in the reverse flow combustion purifier 230. In step 1014, the heated compressed gas from the reverse flow combustion purifier is provided to the turbine. In step 1016, power is generated by driving the turbine using the heated compressed gas. In step 1018, the power generated by the turbine is provided to the compressor. The power provided to the compressor is used to compress the gas.

Several embodiments are specifically illustrated and/or described herein. However, it will be appreciated that modifications and variations are covered by the above teachings and within the scope of the appended claims without departing from the spirit and intended scope thereof. For example, swarms of insects may be ingested by the air cleaning system 100 and oxidized to provide make-up energy to run the system. The air cleaning system 100 may be used to remove pollutants from gases emitted by smoke stacks at industrial installations. The air cleaning system 100 may be used to render toxic gases inert. The air cleaning system 100 may be used to convert carbon monoxide to carbon dioxide in tunnels and mines. Various embodiments of the invention include logic stored on computer readable media, the logic configured to perform methods of the invention.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system for converting particles to particle residue and powering a compressor, the system comprising:
a compressor configured to compress a gas including particles;
a reverse flow combustion purifier configured to:
receive the compressed gas and the particles from the compressor,
heat the compressed gas and particles to a combustion temperature of the particles,
generate particle residue from the heated particles, and
output the particle residue and heated compressed gas; and
a turbine coupled to the compressor, the turbine configured to:
receive the heated compressed gas from the reverse flow combustion purifier,
use the heated compressed gas for producing power, and
provide the produced power to the compressor for driving the compressor.

2. The system of claim 1, wherein the compressed gas and the particles are received from the compressor by an intake chamber, wherein the particles in the compressed gas are heated by a combustion chamber, and the compressed gas and particle residue are output by an exit chamber.

3. The system of claim 2, wherein the reverse flow combustion purifier further comprises a thermal conductor configured to transfer heat from the exit chamber to the intake chamber.

4. The system of claim 2, wherein the reverse flow combustion purifier further comprises a heat source coupled to the combustion chamber, the heat source configured to heat the compressed gas and particles in the combustion chamber.

5. The system of claim 2, further comprising a fuel injector configured to inject a fuel into the combustion chamber for combustion with the compressed gas to heat the compressed gas and particles.

6. The system of claim 1, further comprising a burner manifold coupled to the compressor and the turbine, the burner manifold configured to receive fuel and to receive compressed gas from the compressor for combustion with the fuel to produce a combustion gas, the burner manifold further configured to provide the combustion gas to the turbine for producing power.

7. The system of claim 6, further comprising a fuel injector configured to inject the fuel into a combustion chamber of the reverse flow combustion purifier for combustion with the compressed gas to heat the compressed gas and particles.

8. The system of claim 1, further comprising a burner manifold coupled to the compressor and the intake chamber of the reverse flow combustion purifier, the burner manifold configured to:
receive fuel;
receive compressed gas from the compressor for combustion with the fuel to produce a combustion gas; and
provide the combustion gas to the reverse flow combustion purifier.

9. The system of claim 8, further comprising a fuel injector configured to inject the fuel into a combustion chamber of the reverse flow combustion purifier for combustion with the compressed gas to heat the compressed gas and particles.

10. The system of claim 1, further comprising a burner manifold coupled to the exit chamber of the reverse flow combustion purifier and the turbine, the burner manifold configured to:
receive compressed gas from the exit chamber of the reverse flow combustion purifier;
receive fuel for combustion with the compressed gas to produce a combustion gas; and
provide the combustion gas to the turbine.

11. The system of claim 1, further comprising a reservoir in communication with the compressor and the turbine, the reservoir configured to store the compressed gas.

12. The system of claim 1, wherein the combustion chamber of the reverse flow combustion purifier includes a catalyst configured to catalyze a reaction between a portion of the compressed gas and the particles to generate the particle residue.

13. The system of claim 12, wherein the catalyzed reaction is a reduction reaction.

14. A method for converting particles in a gas to a residue, the method comprising:
compressing the gas in a compressor, the gas including the particles;
heating the particles in the compressed gas to a first temperature, wherein the particles are heated in a reverse flow combustion purifier;
reacting the heated particles in the reverse flow combustion purifier to convert the heated particles to a particle residue;
providing the heated compressed gas from the reverse flow combustion purifier to a turbine;
generating power by driving the turbine using the heated compressed gas; and
providing the generated power to the compressor to use for compressing the gas.

15. The method of claim 14, further comprising expelling the particle residue from the reverse flow combustion purifier.

16. The method of claim 14, wherein the first temperature is greater than a combustion temperature of the particles.

17. The method of claim 14, wherein heating the compressed gas and the particles to a first temperature comprises:
injecting a fuel into the reverse flow combustion purifier; and
combusting a mixture of the injected fuel and the compressed gas to heat the particles.

18. The method of claim 14, wherein reacting the heated particles comprises combusting the heated particles and a portion of the compressed gas in the presence of a catalyst disposed in a combustion chamber of the reverse flow combustion purifier.

19. The method of claim 14, wherein reacting the heated particles comprises a reduction reaction of the heated particles in the presence of a catalyst disposed in the combustion chamber of the reverse flow combustion purifier.

20. The method of claim 14, further comprising:
providing the compressed gas and the particles to a burner manifold;
injecting a fuel into the burner manifold;
combusting a mixture of the compressed gas and the fuel in the burner manifold to heat the compressed gas to a second temperature; and
providing the heated compressed gas at the second temperature to the reverse flow combustion purifier.

21. The method of claim 14, further comprising:
providing the compressed gas and the particles to a burner manifold;
receiving a fuel into the burner manifold;
heating the compressed gas from combustion of a mixture of the compressed gas and the fuel to a second temperature in the burner manifold; and
providing the heated compressed gas from the burner manifold to the turbine.

22. The method of claim 14, further comprising:
providing the compressed gas and the particles to the combustion purifier at a first pressure;
providing the compressed gas and the particles to a burner manifold at a second pressure;
injecting a fuel into the burner manifold;
combusting the injected fuel in the compressed gas at the second pressure in the burner manifold to produce a combustion gas; and
providing the combustion gas to the turbine.

23. The method of claim 14, further comprising:
transporting the compressor, the reverse flow combustion purifier, and the turbine on a vehicle;
receiving ambient air into the compressor while the vehicle is in motion, the ambient air including the gas and the particles; and
expelling the particle residue from the reverse flow combustion purifier while the vehicle is in motion.

24. A system for converting particles to a particle residue, the system comprising:
a first compressor configured to compress a gas to a first pressure, the gas including particles;
a reverse flow combustion purifier including:
an intake chamber configured to receive the compressed gas from the first compressor at the first pressure,
a combustion chamber configured to receive the compressed gas from the intake chamber and heat the compressed gas and included particles to a combustion temperature of the particles to generate a particle residue from combustion of the particles,
an exit chamber configured to receive the particle residue and the heated compressed gas from the burner chamber and to expel the particle residue and the heated compressed gas from the combustion purifier, and
a thermal conductor disposed between the intake chamber and the exit chamber, the thermal conductor configured to transfer heat from the heated compressed gas and particle residue in the exit chamber to the compressed gas in the intake chamber.

25. The system of claim 24, further comprising a power source configured to drive the first compressor.

26. The system of claim 24, further comprising a turbine coupled to the reverse flow combustion purifier, the turbine configured to receive the heated compressed gas from the reverse flow combustion purifier for driving the turbine to generate power, the turbine further coupled to the first compressor and configured to provide the generated power to the first compressor.

27. The system of claim 26, further comprising:
a burner manifold coupled to the first compressor and the turbine, the burner manifold configured to receive the compressed gas from the first compressor at the first pressure and a combustion temperature of a fuel; and
a fuel injector coupled to the burner manifold and configured to inject the fuel for combustion with the compressed gas at the first pressure within the burner manifold to produce a combustion gas, the burner manifold further configured to provide the combustion gas to the turbine.

28. The system of claim 26, further comprising:
a second compressor configured to compress the gas to a second pressure;
a burner manifold coupled to the second compressor and the turbine, the burner manifold configured to receive the compressed gas from the second compressor at the second pressure and a combustion temperature of a fuel; and
a fuel injector coupled to the burner manifold and configured to inject the fuel for combustion with the compressed gas at the second pressure within the burner manifold to produce a combustion gas, the burner manifold further configured to provide the combustion gas to the turbine for driving the first compressor or the second compressor.

29. The system of claim 26, further comprising:
a burner manifold coupled to the first compressor and the combustion purifier, the burner manifold configured to receive the compressed gas from the first compressor at a combustion temperature of a fuel; and
a fuel injector coupled to the burner manifold and configured to inject the fuel for combustion with the compressed gas within the burner manifold to produce a combustion gas, the burner manifold further configured to provide the combustion gas to the combustion purifier.

30. The system of claim 26, further comprising:
a burner manifold coupled to the combustion purifier and the turbine, the burner manifold configured to receive the heated compressed gas from the combustion purifier at a combustion temperature of a fuel; and
a fuel injector coupled to the burner manifold and configured to inject the fuel for combustion with the compressed gas within the burner manifold to produce a combustion gas, the burner manifold further configured to provide the combustion gas to the turbine.

31. The system of claim 24, further comprising a catalyst disposed in the combustion chamber, the catalyst configured to catalyze an exothermic reaction between the heated compressed gas and the particles, the exothermic reaction configured to heat the compressed gas and particles.

32. The system of claim 24, further comprising a fuel injector configured to inject a fuel into the combustion chamber for combustion with the compressed gas to heat the compressed gas and particles.
